(19) United States
(12) Patent Application Publication
(10) Pub. No.: US 2026/0060384 A1
(43) Pub. Date: Mar. 5, 2026

(54) ZIPPER LOCK WITH CONNECTING BUCKLE

(71) Applicant: Dongguan City GeShengMei Industrial Co., Ltd, Dongguan (CN)

(72) Inventor: Taotao Lei, Dongguan (CN)

(21) Appl. No.: 19/379,689

(22) Filed: Nov. 4, 2025

(30) Foreign Application Priority Data
Jul. 17, 2025 (CN) 202521504252.8

(51) Int. Cl. A44B 19/30; E05B 37/02

(52) U.S. Cl. CPC A44B 19/301; E05B 37/02

(57) ABSTRACT

A zipper lock with a connecting buckle includes a lock head clamping plate, a lock device, and a connecting buckle. The lock head clamping plate is connected to a bottom of the lock device, the lock head clamping plate is configured to lock a zipper, the connecting buckle is configured to be detachably connected to a fixed handle of a zipper head, and the lock device is configured to lock the connecting buckle; whereby the lock device locks the fixed handle of the zipper head via locking engagement between the lock device and the connecting buckle. The zipper lock has a simple structure, low cost, and compatibility with zipper heads of various sizes.

### CROSS REFERENCE TO RELATED APPLICATIONS

The present application claims the benefit of Chinese Patent Application No. 202521504252.8 filed on July 17, 2025, the contents of which are incorporated herein by reference in their entirety.

### FIELD OF THE INVENTION

The present invention relates to the field of locks, and in particular, to a zipper lock with a connecting buckle.

### BACKGROUND OF THE INVENTION

Zippers are common items in daily life, and they are used in a variety of applications such as suitcases, travel backpacks, school bags, handbags, portable tents, and mosquito nets. Most of these items do not come with locking mechanisms, which may lead to the theft, damage, malicious alteration, or exposure of personal belongings or important documents.

Chinese Patent No. CN222909707U discloses a zipper lock with a connecting buckle, which is directly locked to a hole in the movable part of a zipper head to achieve the purpose of locking the zipper head. However, some zipper heads have holes in their movable parts that are too small or do not match in size, making it impossible for the aforementioned zipper lock with a connecting buckle to connect to zipper heads of such dimensions. Thus, it fails to meet existing production demands.

Therefore, there is an urgent need for a zipper lock with a connecting buckle to address the aforementioned issues.

### SUMMARY OF THE INVENTION

The objective of the invention is to provide a zipper lock with a connecting buckle that features a simple structure, low cost, and compatibility with zipper heads of various sizes.

In order to achieve the objective mentioned above, the present invention provides a zipper lock with a connecting buckle including a lock head clamping plate, a lock device, and a connecting buckle. The lock head clamping plate is connected to a bottom of the lock device, the lock head clamping plate is configured to lock a zipper, the connecting buckle is configured to be detachably connected to a fixed handle of a zipper head, and the lock device is configured to lock the connecting buckle; whereby the lock device locks the fixed handle of the zipper head via locking engagement between the lock device and the connecting buckle.

Preferably, the connecting buckle is provided with a locking hole, and the lock device is connected to the connecting buckle through the locking hole.

Preferably, the connecting buckle includes a connecting buckle main body, a clamping ring, and a first locking member; the clamping ring is provided with an opening structure for allowing the fixed handle of the zipper head to extend thereinto; the connecting buckle main body is provided with a blocking portion corresponding to the opening structure; the connecting buckle main body is connected to the clamping ring via the first locking member, such that the blocking portion blocks an opening of the opening structure and closes the opening structure; the connecting buckle main body extends outward to form an extension portion, and the locking hole is provided in the extension portion.

Preferably, the clamping ring is provided with a connection hole; the connecting buckle main body is provided with a locking groove corresponding to the connection hole; the first locking member passes through the connection hole and is connected to the locking groove, thereby connecting the connecting buckle main body to the clamping ring.

Preferably, the lock head clamping plate includes an upper connecting member, a lower pressing plate, and a second locking member; the upper connecting member is connected to the bottom of the lock device; the lower pressing plate is located below the upper connecting member, such that a clamping space for accommodating the zipper is formed between the upper connecting member and the lower pressing plate; the second locking member locks a relative position between the upper connecting member and the lower pressing plate, causing the upper connecting member and the lower pressing plate to jointly clamp the zipper.

Preferably, the upper connecting member is provided with a threaded hole; the lower pressing plate is provided with a through hole corresponding to the threaded hole; the second locking member is a bolt; the threaded hole, the through hole, and the second locking member correspond to each other; the second locking member is connected to the threaded hole through the through hole to lock the relative position between the upper connecting member and the lower pressing plate.

Preferably, the lock device is an electronic lock including a first housing, an electronic assembly, a drive mechanism, a first elastic member, and a first lock tongue. Preferably, the first housing is connected to the lock head clamping plate, and the electronic assembly and the drive mechanism are both built into the first housing. Preferably, the drive mechanism is electrically connected to the electronic assembly, and an output end of the drive mechanism is connected to the first lock tongue. Preferably, the first lock tongue is provided with a locking position for locking the connecting buckle and a release position for releasing the connecting buckle. The first elastic member provides an elastic force that constantly biases the first lock tongue to move from the release position to the locking position, and the first lock tongue is driven by the drive mechanism to overcome the elastic force of the first elastic member and move from the locking position to the release position.

Preferably, the output end of the drive mechanism is provided with an abutting head that is retractable; the first lock tongue is movably arranged in the first housing in a liftable manner; the first lock tongue is provided with a matching drive portion corresponding to the abutting head; the abutting head abuts against the matching drive portion and drives the first lock tongue to move up and down; the abutting head has an arc surface, and the matching drive portion has a matching arc surface corresponding to the arc surface.

Preferably, the drive mechanism is an electrically powered thermal contraction wire.

Preferably, the lock device is a combination lock device including a second housing, a sliding drive member, a combination lock, a second lock tongue, a second elastic member, and a third elastic member.

Preferably, the second housing is connected to the lock head clamping plate, the sliding drive member is slidably arranged inside the second housing and is provided with a first position and a second position, and the combination lock is configured to lock the sliding drive member in the second position.

Preferably, the second elastic member is arranged on the sliding drive member and provides an elastic force that constantly biases the sliding drive member to move from the first position to the second position, and the second lock tongue is driven by the sliding drive member to move, thereby providing a locking position for locking the connecting buckle and a release position for releasing the connecting buckle.

Preferably, the third elastic member is arranged on the second lock tongue and provides an elastic force that constantly biases the second lock tongue to move from the release position to the locking position. When the combination lock releases the sliding drive member, the sliding drive member is pushed to move from the second position to the first position, thereby overcoming the elastic force of the second elastic member and abutting against the second lock tongue to move from the locking position to the release position.

Compared to the prior art, the zipper lock provided by the application includes a connecting buckle that can be detachably connected to a fixed handle of an external zipper head. This allows the lock device to indirectly lock the zipper head by directly locking the connecting buckle. The lock device can adapt for zipper heads of different sizes, which is not limited to connecting only with the movable handle of the zipper head. The application offers advantages such as a simple structure, low cost, and strong applicability.

### BRIEF DESCRIPTION OF THE DRAWINGS

FIG. 1 is a schematic perspective view of the zipper lock with a connecting buckle according to the application when engaged with a zipper.

FIG. 2 is a schematic perspective view of the zipper lock with a connecting buckle according to the application.

FIG. 3 is an exploded view of the zipper lock with a connecting buckle according to the application when the lock device is an electronic lock.

FIG. 4 is another exploded view of the zipper lock with a connecting buckle according to the application when the lock device is an electronic lock.

FIG. 5 is an exploded view of the connecting buckle of the zipper lock according to the application when engaged with the fixed handle of a zipper head.

FIG. 6 is another exploded view of the connecting buckle of the zipper lock according to the application when engaged with a fixed handle of a zipper head.

FIG. 7 is a schematic perspective view of the zipper lock with a connecting buckle according to the application when the lock device is a combination lock.

FIG. 8 is a schematic internal structure view of the zipper lock with a connecting buckle according to the application when the lock device is a combination lock.

### DETAILED DESCRIPTION OF ILLUSTRATED EMBODIMENTS

To provide a detailed explanation of the technical content, structural features, and achieved effects of the application, the following description is explained in conjunction with embodiments and the drawings.

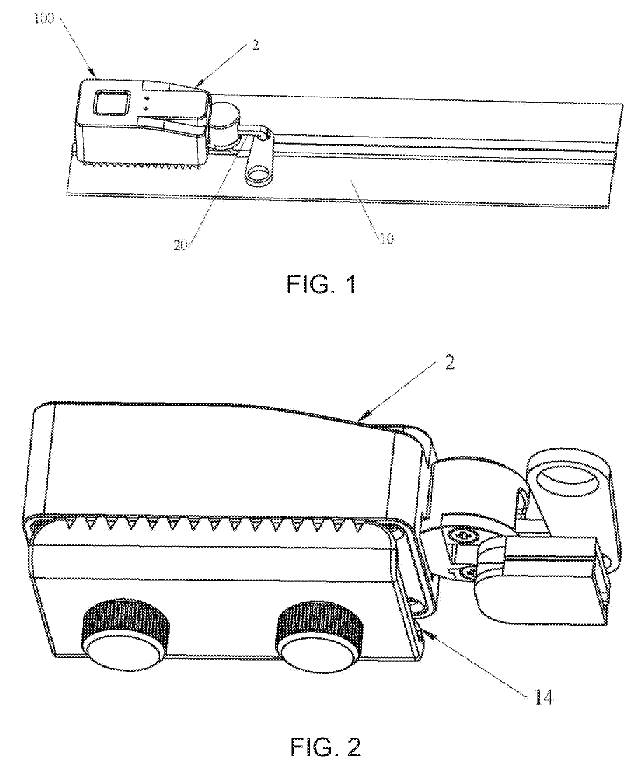

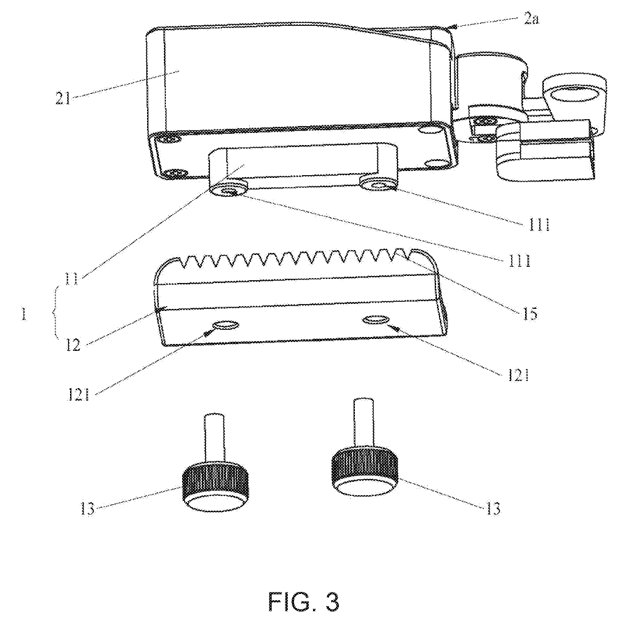

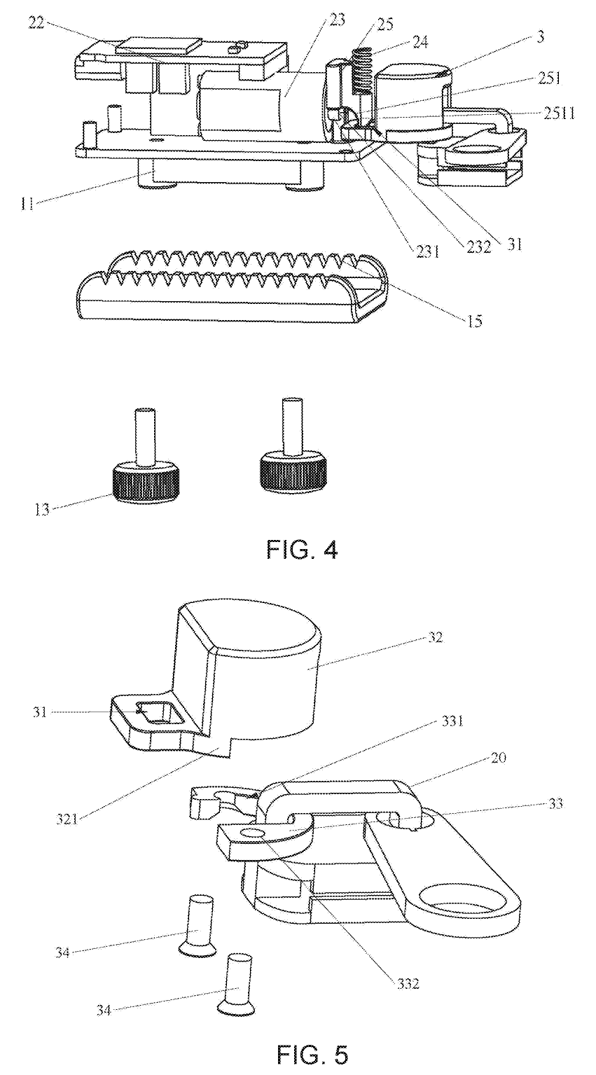

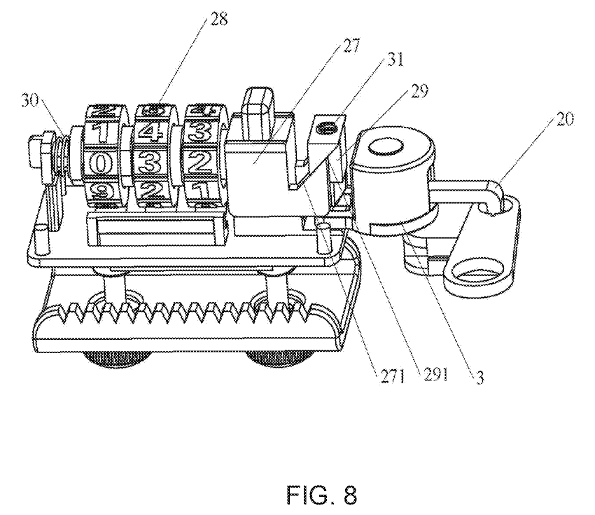

FIGS. 1 to 8 illustrate the specific structure of the zipper lock with a connecting buckle 100 according to the application. The zipper lock with a connecting buckle 100 includes a lock head clamping plate 1, a lock device 2, and a connecting buckle 3. The lock head clamping plate 1 is connected to the bottom of the lock device 2. The lock head clamping plate 1 is used for locking the zipper 10. The connecting buckle 3 is used for detachably connecting to the fixed handle 20 of a zipper head. The lock device 2 is used for locking the connecting buckle 3. By means of the locking engagement between the lock device 2 and the connecting buckle 3, the lock device 2 locks the fixed handle 20 of the zipper head. The connecting buckle 3 can be detachably connected to the fixed handle 20 of an external zipper head. Thus, by directly locking the connecting buckle 3, the lock device 2 can indirectly lock the zipper head. The lock device 2 can adapt for zipper heads of different sizes, which is not limited to connecting only with the movable handle of the zipper head. This offers advantages such as simple structure, low cost, and strong applicability.

More specifically, referring to FIGS. 5 to 8, the connecting buckle 3 has a locking hole 31. The lock device 2 is connected to the connecting buckle 3 through the locking hole 31. The connecting buckle 3 includes a connecting buckle main body 32, a clamping ring 33, and a first locking member 34. The clamping ring 33 has an opening structure 331 for allowing the fixed handle 20 of the zipper head to extend thereinto. The connecting buckle main body 32 is provided with a blocking portion 321 corresponding to the opening structure 331. The connecting buckle main body 32 is connected to the clamping ring 33 via the first locking member 34, such that the blocking portion 321 blocks the opening of the opening structure 331 and closes the opening structure 331. When the opening structure 331 is closed, the blocking portion 321 and the opening structure 331 together form a closed loop, which locks the fixed handle 20 of the zipper head. When the opening structure 331 is opened, the fixed handle 20 of the zipper head can freely enter and exit the opening structure 331. The connecting buckle main body 32 extends outward to form an extension portion 321, and the locking hole 31 is provided in the extension portion 321. In other embodiments, the first locking member 34 may be omitted, and the connection between the connecting buckle main body 32 and the clamping ring 33 may be achieved through an engagement structure. In other embodiments, the connecting buckle 3 may also be a closed-loop ring structure. When connection to the zipper head is needed, the opening at the fixed handle 20 of the zipper head is pried open to achieve the connection.

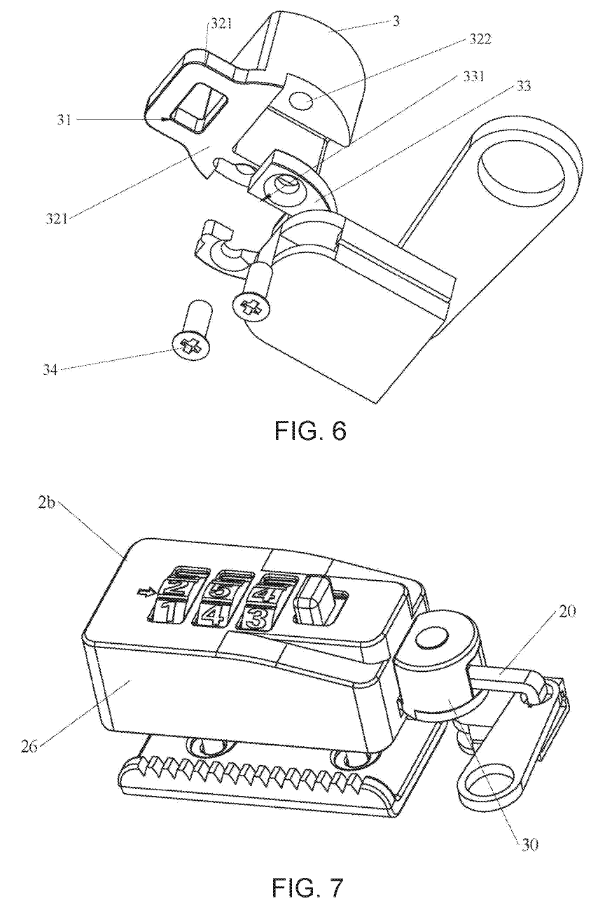

Referring to FIGS. 5 to 6, the clamping ring 33 has a connection hole 332. The connecting buckle main body 32 has a locking groove 322 corresponding to the connection hole 332. The first locking member 34 passes through the connection hole 332 and is connected to the locking groove 322, thereby connecting the connecting buckle main body 32 to the clamping ring 33. The first locking member 34 is a bolt, and both the connection hole 332 and the locking groove 322 are provided with corresponding threaded holes 111.

Referring to FIGS. 1 to 4, the lock head clamping plate 1 includes an upper connecting member 11, a lower pressing plate 12, and a second locking member 13. The upper connecting member 11 is connected to the bottom of the lock device 2. The lower pressing plate 12 is located below the upper connecting member 11, such that a clamping space 14 for accommodating the zipper 10 is formed between the upper connecting member 11 and the lower pressing plate 12. The second locking member 13 locks the relative position between the upper connecting member 11 and the lower pressing plate 12, causing the upper connecting member 11 and the lower pressing plate 12 to jointly clamp the zipper 10. It is seen that, the adjustability of the second locking member 13 allows the spacing of the clamping space 14 to be adjusted, thereby adapting to the zippers 10 of different thicknesses and offering strong applicability. Specifically, the edge of the lower pressing plate 12 extends outward to form a pressing edge 15, and the pressing edge 15 has wave patterns for anti-slip purposes. Referring to FIGS. 1 to 4, the upper connecting member 11 is provided with a threaded hole 111. The lower pressing plate 12 is provided with a through hole 121 corresponding to the threaded hole 111. The second locking member 13 is a bolt. The threaded hole 111, the through hole 121, and the second locking member 13 correspond to each other. The second locking member 13 is connected to the threaded hole 111 through the through hole 121 to lock the relative position between the upper connecting member 11 and the lower pressing plate 12. The upper connecting member 11 extends downward toward the lower pressing plate 12 to form a mounting portion, and the threaded hole 111 is provided in the upper connecting member 11.

Referring to FIGS. 1 to 4, for example, the lock device 2 can be an electronic lock 2a or a combination lock device 2b. In this embodiment, the lock device 2 is the electronic lock 2a which includes a first housing 21, an electronic assembly 22, a drive mechanism 23, a first elastic member 24, and a first lock tongue 25. The first housing 21 is connected to the lock head clamping plate 1. The electronic assembly 22 and the drive mechanism 23 are both built into the first housing 21. The drive mechanism 23 is electrically connected to the electronic assembly 22. An output end of the drive mechanism 23 is connected to the first lock tongue 25. The first lock tongue 25 has a locking position for locking the connecting buckle 3 and a release position for releasing the connecting buckle 3. The first elastic member 24 provides an elastic force that constantly biases the first lock tongue 25 to move from the release position to the locking position. The first lock tongue 25 is driven by the drive mechanism 23 to overcome the elastic force of the first elastic member 24 and move from the locking position to the release position.

Referring to FIGS. 1 to 4, the output end of the drive mechanism 23 has an abutting head 231 that is retractable. The first lock tongue 25 is movably arranged in the first housing 21 in a liftable manner. The first lock tongue 25 is provided with a matching drive portion 251 corresponding to the abutting head 231. The abutting head 231 abuts against the matching drive portion 251 and drives the first lock tongue 25 to move up and down. The abutting head 231 has an arc surface 232, and the matching drive portion 251 has a matching arc surface 2511 corresponding to the arc surface 232. The cooperation between the arc surface 232 and the matching arc surface 2511 can guide the driving of the lock tongue to move up and down. In this embodiment, the drive mechanism 23 is a motor. The motor is connected to the abutting head 231 via a linkage assembly. As converting motor rotation to linear motion is well-known to those skilled in the art, it will not be repeated here. In other embodiments, the drive mechanism 23 is an electrically powered thermal contraction wire. The electrically powered thermal contraction wire is a special conductive wire that contracts as a whole when energized. The contraction drives the mechanical movement of the lock tongue, thereby achieving the purpose of unlocking and locking.

Referring to FIGS. 1 to 4, the electronic assembly 22 includes a touch panel (not shown), a charging port (not shown), a battery (not shown), and an indicator light (not shown). The battery is built into the first housing 21. The touch panel is electrically connected to the battery. The charging port is provided on the housing and is electrically connected to the battery. The indicator light is provided on the touch panel. The drive mechanism 23 is electrically connected to the touch panel and the battery, respectively. In this embodiment, the touch panel is a touch screen panel. Personal fingerprints or passwords can be preset on the touch panel, and the operation of the drive mechanism 23 is controlled by inputting the fingerprint or password.

Referring to FIGS. 5 to 6, the lock device 2 is a combination lock device 2b which includes a second housing 26, a sliding drive member 27, a combination lock 28, a second lock tongue 29, a second elastic member 30, and a third elastic member 31. The second housing 26 is connected to the lock head clamping plate 1. The sliding drive member 27 is slidably arranged inside the second housing 26 and has a first position and a second position. The combination lock 28 is used to lock the sliding drive member 27 in the second position. When the combination lock 28 is released, the sliding drive member 27 can freely switch between the first position and the second position. The second elastic member 30 is arranged on the sliding drive member 27. The second elastic member 30 provides an elastic force that constantly biases the sliding drive member 27 to move from the first position to the second position. The second lock tongue 29 is driven by the sliding drive member 27 to move, thereby providing a locking position for locking the connecting buckle 3 and a release position for releasing the connecting buckle 3. The third elastic member 31 is arranged on the second lock tongue 29. The third elastic member 31 provides an elastic force that constantly biases the second lock tongue 29 to move from the release position to the locking position. When the combination lock 28 releases the sliding drive member 27, by pushing the sliding drive member 27 to move from the second position to the first position (i.e., moving leftwards), the sliding drive member 27 overcomes the elastic force of the second elastic member 30 and abuts against the second lock tongue 29, causing it to overcome the elastic force of the third elastic member 31 and move from the locking position to the release position. When locking, the combination lock 28 locks the sliding drive member 27 in the second position. The sliding drive member 27, under the action of the second elastic member 30, moves from the first position to the second position (i.e., moving rightwards). The second lock tongue 29, no longer abutted by the sliding drive member 27, resets from the release position to the locking position. The sliding drive member 27 has an abutting inclined surface 271, and the second lock tongue 29 has a matching surface 291 corresponding to the abutting inclined surface 271.

Referring to FIGS. 1 to 8, the working process of the zipper lock 100 according to the application is as follows.

During use, the user simply opens the zipper 10 to be installed, places the zipper lock 100 at the end of the zipper 10, and uses the clamping between the upper connecting member 11 and the lower pressing plate 12 to clamp both sides of the zipper 10. At this point, the zipper lock 100 of the application is fixed on the zipper 10.

The connecting buckle 3 is opened to allow the fixed handle 20 of the zipper head to extend into the opening structure 331 of the clamping ring 33. The connecting buckle main body 32 is connected to the clamping ring 33 via the first locking member 34, such that the blocking portion 321 blocks the opening of the opening structure 331 and closes the opening structure 331. When the opening structure 331 is closed, the blocking portion 321 and the opening structure 331 together form a closed loop, which locks the fixed handle 20 of the zipper head. Taking the electronic lock 2a as an example, the drive mechanism 23 is activated by manually operating the touch panel or buttons. The first lock tongue 25 is driven by the drive mechanism 23 to overcome the elastic force of the first elastic member 24 and move from the locking position to the release position. The locking hole 31 of the connecting buckle 3 is inserted below the first lock tongue 25 of the electronic lock 2a. The drive mechanism 23 is activated again by manually operating the touch panel or buttons. The abutting head 231 retracts, and the first lock tongue 25, under the elastic force of the first elastic member 24, moves from the release position to the locking position.

When unlocking, the drive mechanism 23 is activated by manually operating the touch panel using the personal fingerprint or the password set in advance. The drive mechanism 23 drives the first lock tongue 25 to move from the locking position to the release position. The zipper head is now unlocked and can be moved freely.

By providing the connecting buckle 3, which can be detachably connected to the fixed handle 20 of an external zipper head, the lock device 2 can indirectly lock the zipper head by directly locking the connecting buckle 3. The lock device 2 can adapt for zipper heads of different sizes, which is not limited to connecting only with the movable handle of the zipper head. This offers advantages such as simple structure, low cost, and strong applicability.

The above disclosure is only preferred embodiments of the present invention and cannot be used to limit the scope of rights of the present invention. Therefore, any equivalent changes made in accordance with the claims of the present invention are within the scope of the present invention.

What is claimed is:

1. A zipper lock with a connecting buckle, comprising a lock head clamping plate, a lock device, and a connecting buckle;
wherein the lock head clamping plate is connected to a bottom of the lock device, the lock head clamping plate is configured to lock a zipper, the connecting buckle is configured to be detachably connected to a fixed handle of a zipper head, and the lock device is configured to lock the connecting buckle; whereby the lock device locks the fixed handle of the zipper head via locking engagement between the lock device and the connecting buckle.

2. The zipper lock with a connecting buckle according to claim 1, wherein the connecting buckle is provided with a locking hole, and the lock device is connected to the connecting buckle through the locking hole.

3. The zipper lock with a connecting buckle according to claim 2, wherein the connecting buckle comprises a connecting buckle main body, a clamping ring, and a first locking member; the clamping ring is provided with an opening structure for allowing the fixed handle of the zipper head to extend thereinto; the connecting buckle main body is provided with a blocking portion corresponding to the opening structure; the connecting buckle main body is connected to the clamping ring via the first locking member, such that the blocking portion blocks an opening of the opening structure and closes the opening structure; the connecting buckle main body extends outward to form an extension portion, and the locking hole is provided in the extension portion.

4. The zipper lock with a connecting buckle according to claim 3, wherein the clamping ring is provided with a connection hole; the connecting buckle main body is provided with a locking groove corresponding to the connection hole; the first locking member passes through the connection hole and is connected to the locking groove, thereby connecting the connecting buckle main body to the clamping ring.

5. The zipper lock with a connecting buckle according to claim 1, wherein the lock head clamping plate comprises an upper connecting member, a lower pressing plate, and a second locking member; the upper connecting member is connected to the bottom of the lock device; the lower pressing plate is located below the upper connecting member, such that a clamping space for accommodating the zipper is formed between the upper connecting member and the lower pressing plate; the second locking member locks a relative position between the upper connecting member and the lower pressing plate, causing the upper connecting member and the lower pressing plate to jointly clamp the zipper.

6. The zipper lock with a connecting buckle according to claim 5, wherein the upper connecting member is provided with a threaded hole; the lower pressing plate is provided with a through hole corresponding to the threaded hole; the second locking member is a bolt; the threaded hole, the through hole, and the second locking member correspond to each other; the second locking member is connected to the threaded hole through the through hole to lock the relative position between the upper connecting member and the lower pressing plate.

7. The zipper lock with a connecting buckle according to claim 1, wherein the lock device is an electronic lock comprising a first housing, an electronic assembly, a drive mechanism, a first elastic member, and a first lock tongue.

8. The zipper lock with a connecting buckle according to claim 7, wherein the first housing is connected to the lock head clamping plate; the electronic assembly and the drive mechanism are both built into the first housing; and the drive mechanism is electrically connected to the electronic assembly.

9. The zipper lock with a connecting buckle according to claim 8, wherein an output end of the drive mechanism is connected to the first lock tongue; the first lock tongue is provided with a locking position for locking the connecting buckle and a release position for releasing the connecting buckle; the first elastic member provides an elastic force that constantly biases the first lock tongue to move from the release position to the locking position; the first lock tongue is driven by the drive mechanism to overcome the elastic force of the first elastic member and move from the locking position to the release position.

10. The zipper lock with a connecting buckle according to claim 9, wherein the output end of the drive mechanism is provided with an abutting head that is retractable; the first lock tongue is movably arranged in the first housing in a liftable manner; the first lock tongue is provided with a matching drive portion corresponding to the abutting head; and the abutting head abuts against the matching drive portion and drives the first lock tongue to move up and down.

11. The zipper lock with a connecting buckle according to claim 10, wherein the abutting head has an arc surface, and the matching drive portion has a matching arc surface corresponding to the arc surface.

12. The zipper lock with a connecting buckle according to claim 7, wherein the drive mechanism is an electrically powered thermal contraction wire.

13. The zipper lock with a connecting buckle according to claim 1, wherein the lock device is a combination lock device comprising a second housing, a sliding drive member, a combination lock, a second lock tongue, a second elastic member, and a third elastic member.

14. The zipper lock with a connecting buckle according to claim 13, wherein the second housing is connected to the lock head clamping plate; the sliding drive member is slidably arranged inside the second housing and is provided with a first position and a second position; and the combination lock is configured to lock the sliding drive member in the second position.

15. The zipper lock with a connecting buckle according to claim 14, wherein the second elastic member is arranged on the sliding drive member and provides an elastic force that constantly biases the sliding drive member to move from the first position to the second position; the second lock tongue is driven by the sliding drive member to move, thereby providing a locking position for locking the connecting buckle and a release position for releasing the connecting buckle.

16. The zipper lock with a connecting buckle according to claim 15, wherein the third elastic member is arranged on the second lock tongue and provides an elastic force that constantly biases the second lock tongue to move from the release position to the locking position; when the combination lock releases the sliding drive member, the sliding drive member is pushed to move from the second position to the first position, thereby overcoming the elastic force of the second elastic member and abutting against the second lock tongue to move from the locking position to the release position.
